(19) United States
(12) Patent Application Publication
(10) Pub. No.: US 2004/0204013 A1
(43) Pub. Date: Oct. 14, 2004

(54) Communication unit and switch unit

(76) Inventors: Qing Ma, San Jose, CA (US); Dong S. Shim, San Jose, CA (US); Valluri Rao, Saratoga, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 10/329,050

(22) Filed: Dec. 23, 2002

(51) Int. Cl. H04M 1/00

(52) U.S. Cl. 455/550.1; 455/575.1

(57) ABSTRACT

A communication unit includes a switch unit, and antenna, a transmitter and a receiver. The switch unit includes a plurality of micro-electrical-mechanical system (MEMS) switches and couples the antenna to the transmitter and the receiver. A switch unit includes a die, a first transmission line formed on the die, and a second transmission line formed on the die, and a plurality of MEMS switches. The plurality of MEMS switches couple the first transmission line to the second transmission line.

### FIELD

This invention relates to a communication unit and, more particularly, to a communication unit that includes a switch unit.

### BACKGROUND

To meet the consumer demand for small, high-function communication systems, the architects of each new system generation specify higher performance systems. Higher performance often means lower power consumption, lower signal levels, and higher speed. To achieve higher performance, components, such as transistors, amplifiers, and switches are developed that operate at lower power levels with lower signal levels and lower noise margins.

A switch is sometimes required to connect and disconnect transmitters and receivers from an antenna in a high performance communication system. A transistor is often selected to provide the switching function in these systems. Since the transistor is placed in the signal path of the transmitted and received signals, the transistor's electrical characteristics affect the system performance. For example, a transistor having high insertion loss and poor isolation characteristics places a lower limit on a system's signal levels and noise margins. Unfortunately, despite improvements, transistors still exhibit high insertion loss and poor isolation characteristics. The present invention provides improved performance when compared with systems utilizing transistor switches.

### BRIEF DESCRIPTION OF THE DRAWINGS

FIG. 1A shows a block diagram of a communication unit in accordance with one embodiment of the invention.

FIG. 1B shows a block diagram of a communication unit in accordance with another embodiment of the invention.

FIG. 1C shows the switch unit shown in FIG. 1A packaged on a substrate in accordance with another embodiment of the invention.

FIG. 1D shows a transmitter, receiver, and switch unit included in the communication unit shown in FIG. 1A packaged on a substrate in accordance with another embodiment of the invention.

FIGS. 1E, 1F, 1G, 1H, 1J, 1K, 1L, and 1M show schematic diagrams of the switch unit shown in FIG. 1A in accordance with some embodiments of the invention.

FIG. 2A shows a top view of a micro-electrical-mechanical system (MEMS) series switch suitable for use in connection with the communication unit shown in FIG. 1A in accordance with another embodiment of the invention.

FIG. 2B shows a side view of the MEMS series switch shown in FIG. 2A in an open state.

FIG. 2C shows a side view of the MEMS series switch shown in FIG. 2A in a closed state.

FIG. 3A shows a top view of a broad-side cantilever beam contact series switch suitable for use in connection with the communication unit shown in FIG. 1A in accordance with another embodiment of the invention.

FIG. 3B shows a side view of the broad-side cantilever beam contact series switch shown in FIG. 3A in an open state.

FIG. 3C shows a side view of the broad-side cantilever beam contact series switch shown in FIG. 3A in a closed state.

FIG. 4A shows a top view of a bridge-beam series switch suitable for use in connection with the communication unit shown in FIG. 1A in accordance with another embodiment of the invention.

FIG. 4B shows a side view of the bridge-beam series switch shown in FIG. 4A in an open state.

FIG. 4C shows a side view of the bridge-beam series switch shown in FIG. 4A in a closed state.

FIG. 5A shows a top view of a shunt switch suitable for use in connection with the communication unit shown in FIG. 1A in accordance with another embodiment of the invention.

FIG. 5B shows a side view of the shunt switch shown in FIG. 5A in an open state.

FIG. 5C shows a side view of the shunt switch shown in FIG. 5A in a closed state.

FIG. 6 shows a switch unit suitable for use in connection with the communication unit shown in FIG. 1A in accordance with another embodiment of the invention.

### DESCRIPTION

In the following detailed description of some embodiments of the invention, reference is made to the accompanying drawings which form a part hereof, and in which are shown, by way of illustration, specific embodiments of the invention which may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is not to be taken in a limiting sense, and the scope of the present invention is defined only by the appended claims, along with the full scope of equivalents to which such claims are entitled.

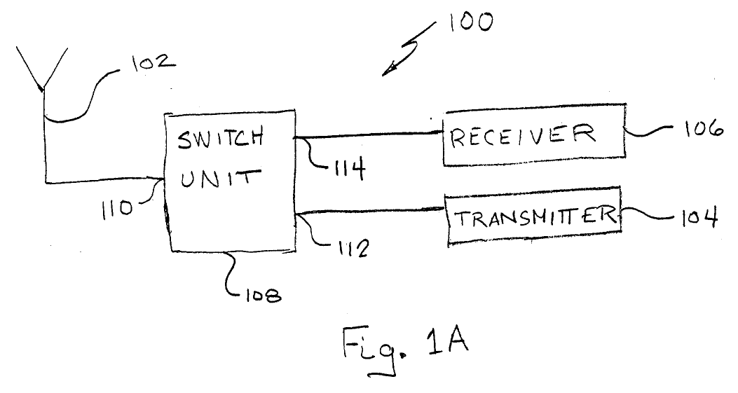

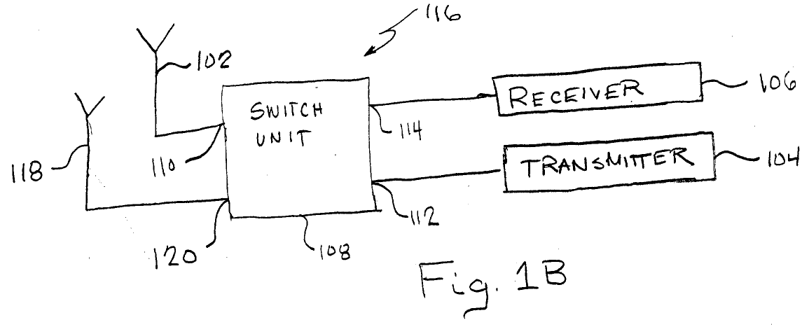

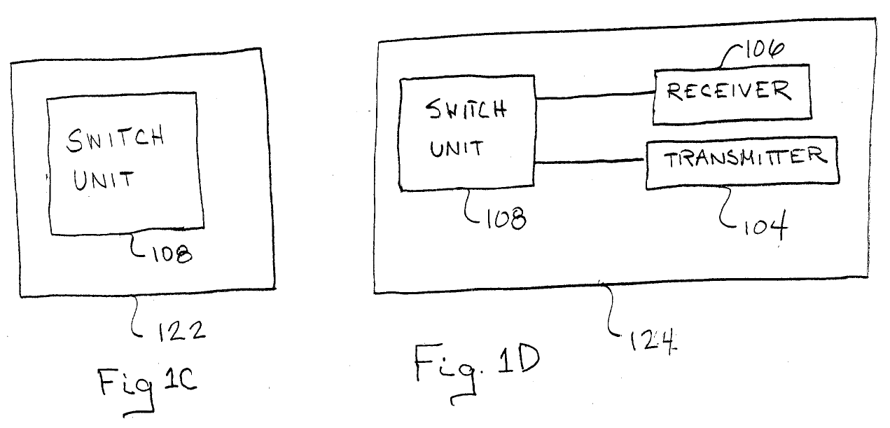

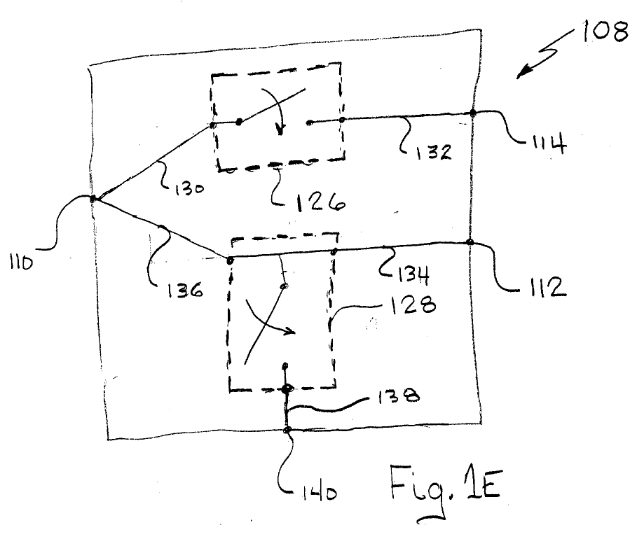

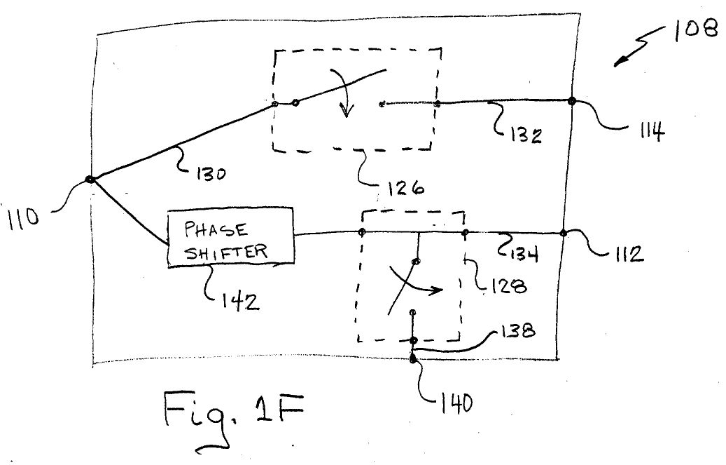

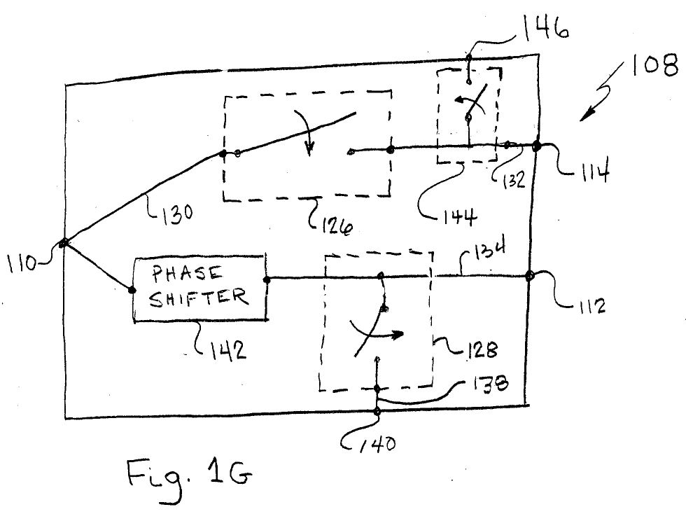

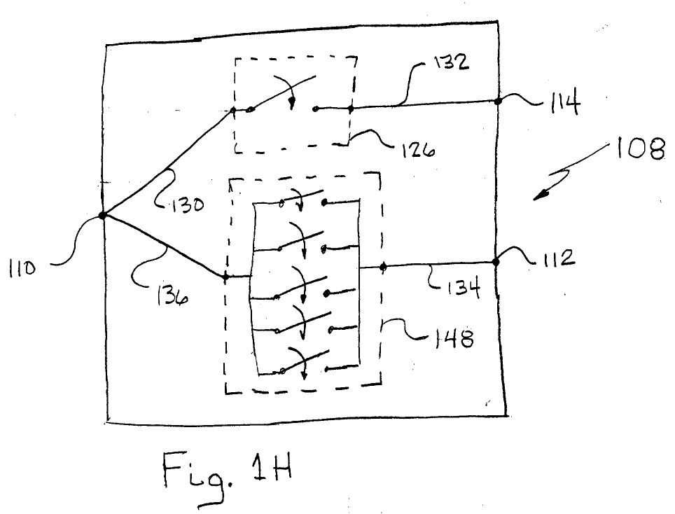

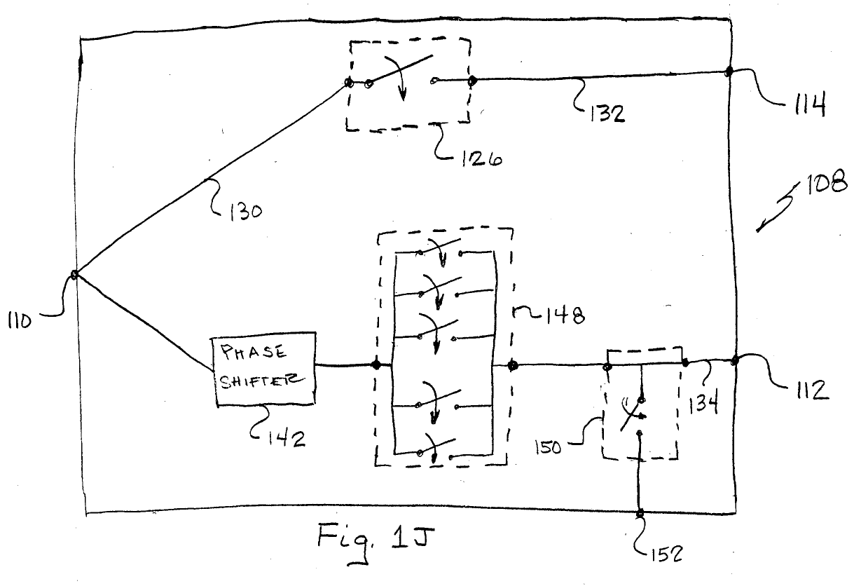

FIG. 1A shows a block diagram of a communication unit 100 in accordance with one embodiment of the invention. The communication unit 100 includes an antenna 102, a transmitter 104, a receiver 106, and a switch unit 108. The switch unit 108 includes ports 110, 112, and 114. The switch unit 108 couples the antenna 102 to the transmitter 104 and the receiver 106. The antenna 102 is coupled to the switch unit 108 at the port 110. The transmitter 104 is coupled to the switch unit 108 at the port 112. The receiver 106 is coupled to the switch unit 108 at the port 114.

The communication unit 100 transmits, receives, and processes information. However, the communication unit 100 is not limited to use in connection with a particular type of information. Exemplary types of information suitable for use in connection with the communication unit 100 include auditory information, such as voice communications, visual information, such as photographs and video images, and print information, such as news and stock market quotes. The communication unit 100 is also not limited to a particular type of communication unit. In one embodiment, the communication unit 100 is a cellular telephone. In an alternate embodiment, the communication unit 100 is a personal digital assistant. In another alternate embodiment, the communication unit 100 is a cellular base station. In still another alternate embodiment, the communication unit 100 is a wireless base station.

The antenna 102 is a transition device between a guided wave and a free-space wave or between a free-space wave and a guided wave. The communication unit 100 is not limited to use in connection with a particular type of antenna. In one embodiment, the antenna 102 is a short dipole antenna. In an alternate embodiment, the antenna 102 is a cellular base station antenna including a triangular ground plane and three λ/2 dipoles. In another alternate embodiment, the antenna 102 is an opened-out coaxial antenna. In still another alternate embodiment, the antenna 102 is an opened-out waveguide antenna.

The transmitter 104 is an electronic device or system that generates a signal to drive the antenna 102. Exemplary signals generated by the transmitter 104 to drive the antenna 102 include analog signals, digital signals, and multilevel signals. The communication unit 100 is not limited to use in connection with a particular type of transmitter or to use in connection with a transmitter operating at a particular frequency. In one embodiment, the transmitter 104 is a Global System for Mobile Communication (GSM) transmitter. In an alternate embodiment, the transmitter 104 is a Code Division Multiple Access (CDMA) transmitter. In another alternate embodiment, the transmitter 104 is a combination GSM and CDMA transmitter. In still another alternate embodiment, the transmitter 104 generates a signal having a frequency of about 931 megahertz (MHz). In yet another alternate embodiment, the transmitter 104 generates one or more signals having a frequency of between about 500 megahertz (MHz) and about 2 gigahertz.

The receiver 106 is an electronic device or system that receives and processes a signal from the antenna 102. Exemplary types of signals suitable for use in connection with the receiver 106 include analog signals, digital signals, and multilevel signals. The communication unit 100 is not limited to use in connection with a particular type of receiver or to a receiver operating at a particular frequency. In one embodiment, the receiver 106 is a Global System for Mobile Communication (GSM) receiver. In an alternate embodiment, the receiver 106 is a Code Division Multiple Access (CDMA) receiver. In another alternate embodiment, the receiver 106 is a combination GSM and CDMA receiver. In still another alternate embodiment, the receiver 106 detects a signal having a frequency of about 931 megahertz (MHz). In yet another alternate embodiment, the receiver 106 detects one or more signals having a frequency of between about 500 megahertz (MHz) and about 2 gigahertz.

The transmitter 104 and the receiver 106 are not limited to being partitioned or packaged in a particular manner. In the communication unit 100 shown in FIG. 1A, the transmitter 104 and the receiver 106 are shown as separate elements, however those skilled in the art will appreciate that the transmitter 104 and the receiver 106 can be designed and packaged as a single electronic unit, which is sometimes referred to as a transceiver.

FIG. 1B shows a block diagram of a communication unit 116 in accordance with another embodiment of the invention. The communication unit 116 includes, in addition to the communication unit 100 (which includes the antenna 102 coupled to the switch unit 108 at the port 110, the receiver 106 coupled to the switch unit 108 at the port 114, and the transmitter 104 coupled to the switch unit 108 at the port 112) shown in FIG. 1A, an antenna 118 coupled to the switch unit 108 at a port 120. The antenna 118 enables the communication unit 116 to provide communication options not available in the communication unit 100 (shown in FIG. 1A). For example, in one embodiment, the antenna 118 is designed to transmit and receive a different range of frequencies than the antenna 102. Thus, the communication unit 116 operates over a wider bandwidth than the communication unit 102. Those skilled in the art, having seen the extension of the communication unit 100 to the communication unit 116, will appreciate that the communication unit 100 is extendible to any number of antennae.

FIG. 1C shows the switch unit 108 shown in FIG. 1A packaged on a substrate 122 in accordance with another embodiment of the invention. The switch unit 108 includes a plurality of micro-electrical-mechanical systems (MEMS) switches (shown in FIGS. 1E, 1F, 1G, 1H, 1J, 1K, 1L, and 1M). A MEMS switch is an integrated microdevice or microsystem that combines electrical and mechanical components to perform a switch function. The switch unit 108 is not limited to being formed on a particular type of substrate. In one embodiment, the substrate 122 is a silicon substrate. In an alternate embodiment, the substrate 122 is a gallium arsenide substrate. In another alternate embodiment, the substrate 122 is a germanium substrate. In still another alternate embodiment, the substrate 122 is a silicon-on-sapphire substrate. In yet another embodiment, the substrate 122 is a germanium-on-silicon substrate.

FIG. 1D shows the transmitter 104, the receiver 106, and the switch unit 108 included in the communication unit 100 shown in FIG. 1A packaged on a substrate 124 in accordance with another embodiment of the invention. The switch unit 108 includes a plurality micro-electrical-mechanical systems (MEMS) switches (shown in FIGS. 1E, 1F, 1G, 1H, 1J, 1K, 1L, and 1M). The switch unit 108 is not limited to being formed on a substrate of a particular material. In one embodiment, the substrate 124 is a silicon substrate. In an alternate embodiment, the substrate 124 is a gallium arsenide substrate. In another alternate embodiment, the substrate 124 is a germanium substrate. In still another alternate embodiment, the substrate 124 is a silicon-on-sapphire substrate. In yet another alternate embodiment, the substrate 124 is a germanium-on-silicon substrate.

Some embodiments of the switch unit 108 are shown in FIGS. 1E, 1F, 1G, 1H, 1J, 1K, 1L, and 1M. Terms used in the description of these embodiments include “interconnect,” “transmitter,” “receiver,” and “MEMS switch.” “Interconnect” refers to a conductive path or coupling between electronic components. For example, in an integrated circuit transistor amplifier, an interconnect can refer to the conductive path that couples the source resistance of a signal source to a gate of a transistor in the integrated circuit transistor amplifier. Exemplary interconnects include conductive strips, formed from materials such as copper or aluminum, and transmission lines, such as microstrip transmission lines. A microstrip transmission line is formed by fabricating a conductive strip above a conductive plane. “Transmitter” and “receiver” modify the phrase “MEMS series switch” and similar phrases. In that context, “transmitter” and “receiver” are intended to identify the electronic device or system (“transmitter” or “receiver”) coupled to the MEMS series switch. “Transmitter” and “receiver” are not intended to denote a particular type of switch.

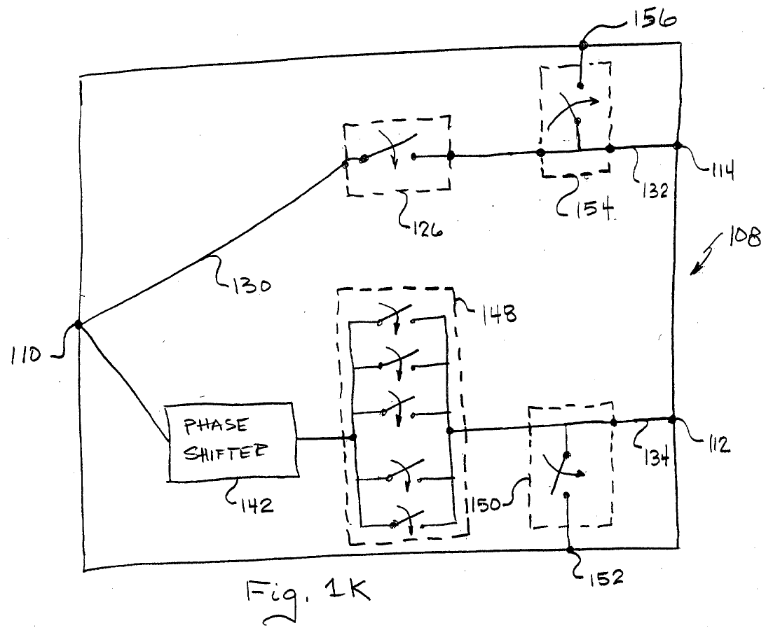

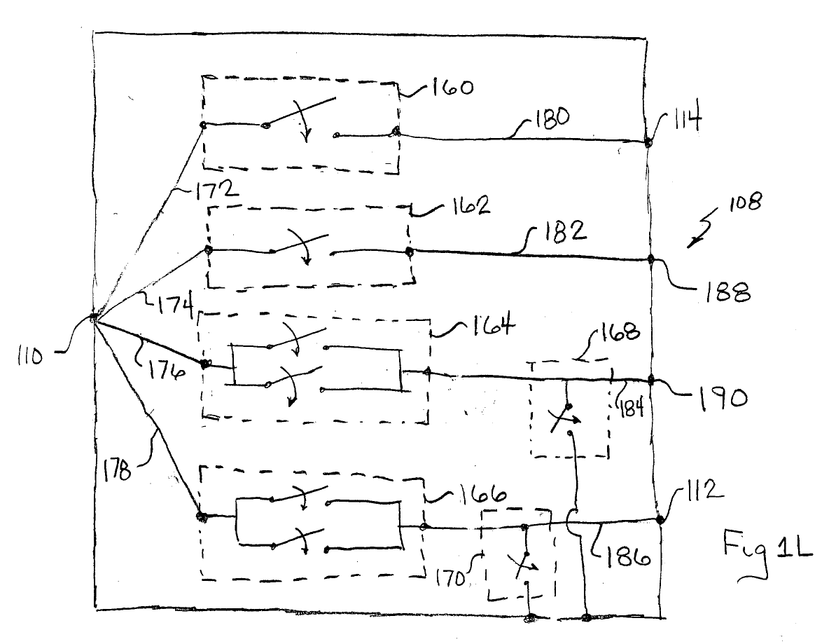

Each of the switch units described below includes references to specific types of switches. Exemplary embodiments of switches suitable for use in connection with the embodiments of the switch unit 108 shown in FIGS. 1E, 1F, 1G, 1H, 1J, 1K, 1L, and 1M are shown in FIGS. 2A, 3A, 4A, and 5A.

FIG. 1E shows a schematic diagram of the switch unit 108 shown in FIG. 1A in accordance with another embodiment of the invention. The switch unit 108 includes a receiver MEMS series switch 126, a transmitter MEMS shunt switch 128, interconnects 130, 132, 134, 136, and 138, the ports 110, 112, and 114, and a port 140. The interconnect 130 couples the port 110 to the receiver MEMS series switch 126. The interconnect 132 couples the receiver MEMS series switch 126 to the port 114. The interconnect 134 couples the transmitter MEMS shunt switch 128 to the port 112. The interconnect 136 couples the transmitter MEMS shunt switch 128 to the port 110. The interconnect 138 couples the transmitter MEMS shunt switch 128 to the port 140.

In operation, the switch unit 108 is in either a transmit mode or a receive mode. In the transmit mode, the transmitter MEMS shunt switch 128 is open (the port 110 is coupled to the port 112), and the receiver MEMS series switch 126 is open (the port 110 is decoupled from the port 114). A signal at the port 112 travels through the interconnects 134 and 136 to the port 110. In the receive mode, the transmitter MEMS shunt switch 128 is closed (the port 112 is coupled to the port 140), and the receiver MEMS series switch 126 is closed (the port 110 is coupled to the port 114). A signal at the port 110 travels through the interconnect 130, the receiver MEMS series switch 126, and the interconnect 132 to the port 114. Coupling the port 140 to a zero potential (not shown) substantially eliminates any residual signal at the port 112 from being coupled to the port 110 and corrupting the signal at the port 110.

FIG. 1F shows a schematic diagram of the switch unit 108 shown in FIG. 1A in accordance with another embodiment of the invention. The switch unit 108 (including the ports 110, 112, 114, and 140, the receiver MEMS series switch 126, the transmitter MEMS shunt switch 128, and the interconnects 130, 132, 134, and 138, shown in FIG. 1E) shown in FIG. 1F is formed by replacing the interconnect 136 shown in FIG. 1E with a phase shifter 142. In one embodiment, the phase shifter 142 is a ninety-degree phase shifter. A ninety-degree phase shifter is formed by selecting an interconnect length to provide a ninety-degree phase shift at the receiving frequency. Microstrip interconnects can be sized and trimmed for a ninety-degree phase shift. Inserting a ninety-degree phase shifter, such as a microstrip, between the port 110 and transmitter MEMS shunt switch 128 prevents the port 110 from being shorted to the transmitter MEMS shunt switch 128 when the switch unit 108 is in the receive mode.

FIG. 1G shows a schematic diagram of the switch unit 108 shown in FIG. 1A in accordance with another embodiment of the invention. The switch unit 108 (including the ports 110, 112, 114, and 140, the receiver MEMS series switch 126, the transmitter MEMS shunt switch 128, interconnects 130, 132, 134, and 138, and the phase shifter 142 shown in FIG. 1F) shown in FIG. 1G is formed by connecting a receiver MEMS shunt switch 144 between the interconnect 132 and a port 146. In the transmit mode, the receiver MEMS shunt switch 144 is closed and provides a path from the port 114 to the port 146. In the communication unit 100 (shown in FIG. 1A), coupling the port 146 to a zero potential (not shown) protects the receiver 106 (shown in FIG. 1A) from electrostatic charge build-up at the port 114 by providing a discharge path from the port 114 to a zero potential at the port 146. In the communication unit 100, coupling the port 146 to a zero potential also increases the isolation between the receiver 106 and the transmitter 104 (shown in FIG. 1A).

FIG. 1H shows a schematic diagram of the switch unit 108 shown in FIG. 1A in accordance with another embodiment of the invention. The switch unit 108 (including the ports 110, 112, and 114, the receiver MEMS series switch 126, and the interconnects 130, 132, 134, and 136 shown in FIG. 1E) shown in FIG. 1H is formed by replacing the transmitter MEMS shunt switch 128 shown in FIG. 1E with the transmitter MEMS series switch array 148. In transmit mode, the transmitter MEMS series switch array 148 is closed. A signal at the port 112 travels through the interconnect 134, the transmitter MEMS series switch array 148, and the interconnect 136 to the port 110. The number of switches in the transmitter MEMS series switch array 148 is selected to provide current carrying capacity sufficient to carry signals provided by the transmitter 104 (shown in FIG. 1A).

FIG. 1J shows a schematic diagram of the switch unit 108 shown in FIG. 1A in accordance with another embodiment of the invention. The switch unit 108 (including the ports 110, 112, and 114, the receiver MEMS series switch 126, the interconnects 130, 132, and 134, and the transmitter MEMS series switch array 148 shown in FIG. 1H) shown in FIG. 1J is formed by replacing the interconnect 136 shown in FIG. 1H with the phase shifter 142 and connecting a transmitter MEMS shunt switch 150 between the interconnect 134 and a port 152.

In one embodiment, the phase shifter 142 is a ninety-degree phase shifter. A ninety-degree phase shifter is formed by selecting an interconnect length to provide a ninety degree phase shift at the receiving frequency. Microstrip interconnects can be sized and trimmed for a ninety-degree phase shift. Inserting a ninety-degree phase shifter, such as a microstrip, between the port 110 and the transmitter MEMS series switch array 148 prevents the port 110 from being shorted to the transmitter MEMS series switch array 148 when the switch unit 108 is in the receive mode.

In the receive mode, the transmitter MEMS shunt switch 150 is closed and provides a conductive path between the port 112 and the port 152. The conductive path includes the interconnect 134. Coupling the port 152 to a zero potential (not shown) protects the transmitter 104 (shown in FIG. 1A) from electrostatic charge build-up at the port 112 by providing a discharge path from the port 112 to a zero potential at the port 152. Coupling the port 152 to a zero potential also increases the isolation between the transmitter 104 and the receiver 106 (shown in FIG. 1A).

FIG. 1K shows a schematic diagram of the switch unit 108 shown in FIG. 1A in accordance with another embodiment of the invention. The switch unit 108 (including the ports 110, 112, 114, and 152, the receiver MEMS series switch 126, the interconnects 130, 132, and 134, the phase shifter 142, the transmitter MEMS series switch array 148, and the transmitter MEMS shunt switch 150 shown in FIG. 1J) shown in FIG. 1K is formed by connecting a receiver MEMS shunt switch 154 between the interconnect 132 and a port 156. In transmit mode, the receiver MEMS shunt switch 154 is closed and provides a conductive path between the port 114 and the port 156. Coupling the port 156 to a zero potential (not shown) protects the receiver 106 (shown in FIG. 1A) from electrostatic charge build-up at the port 114 by providing a discharge path from the port 114 to a zero potential at the port 156. Coupling the port 156 to a zero potential also increases the isolation between the receiver 106 and the transmitter 104 (shown in FIG. 1A) in the communication unit 100 (shown in FIG. 1A).

FIG. 1L shows a schematic diagram of the switch unit 108 shown in FIG. 1A in accordance with another embodiment of the invention. The switch unit 108 includes receiver MEMS series switches 160 and 162, transmitter MEMS series switch arrays 164 and 166, transmitter MEMS shunt switches 168 and 170, interconnects 172, 174, 176, 178, 180, 182, 184, and 186, the ports 110, 112, and 114, and ports 188 and 190. The interconnects 172, 174, 176, and 178 couple the port 110 to the receiver MEMS series switches 160 and 162 and to the transmitter MEMS series switch arrays 164 and 166. The interconnect 180 couples the receiver MEMS series switch 160 to the port 114. The interconnect 182 couples the receiver MEMS series switch 162 to the port 188. The interconnect 184 couples the transmitter MEMS switch 164 to the port 190. The interconnect 186 couples the transmitter MEMS switch 166 to the port 112.

The switch unit 108 can support several channel configurations. For example, in a two-channel GSM configuration, each of the ports 114 and 188 is connected to a GSM receiver and each of the ports 112 and 190 is connected to a GSM transmitter. Alternatively, in a two channel GSM/CDMA configuration, the port 114 is connected to a GSM receiver, the port 112 is connected to a GSM transmitter, and the port 190 is connected to a CDMA transceiver. Those skilled in the art, having seen a two-channel configuration, will appreciate that the switch unit 108 can be extended to three channels, four channels, five channels and more than five channels.

In operation, the switch unit 108 is in either a transmit mode, a receive mode, or a transceiver mode. In the transmit mode, the receiver MEMS series switches 160 and 162 are open, and either the transmitter series switch array 164 or the transmitter series switch array 166 is closed. If the transmitter series switch array 164 is closed, then the transmitter shunt switch 168 is open and the transmitter shunt switch 170 is closed. A conductive path including the interconnect 184, the series switch array 164, and the interconnect 176 is formed between the port 190 and the port 110. If the transmitter series switch array 166 is closed, then the transmitter shunt switch 170 is open and the transmitter shunt switch 168 is closed. A conductive path including the interconnect 186, the series switch array 166, and the interconnect 178 is formed between the port 112 and the port 110.

In the receive mode, the transmitter series switch arrays 164 and 166 are open, the transmitter shunt switches 168 and 170 are closed, and only one of the receiver series switches 160 and 162 is closed. If the receiver series switch 160 is closed, then a conductive path including the interconnect 180, the receiver series switch 160, and the interconnect 172 is formed between the port 114 and the port 110. If the receiver series switch 162 is closed, then a conductive path including the interconnect 182, the receiver series switch 162, and the interconnect 174 is formed between the port 188 and the port 110.

In the transceiver mode, the receiver series switches 160 and 162 are open, and only one of the series switch arrays 164 or 166 is closed. If the transmitter series switch array 164 is closed, then the transmitter shunt switch 170 is closed and the transmitter shunt switch 168 is open. A conductive path including the interconnect 184, the transmitter series switch array 164, and the interconnect 176, is formed between the port 190 and the port 110. Alternatively, if the transmitter series switch array 166 is closed, then the transmitter shunt switch 168 is closed and the transmitter shunt switch 170 is open. A conductive path including the interconnect 186, the transmitter series switch array 166, and the interconnect 178, is formed between the port 112 and the port 110.

FIG. 1M shows a schematic diagram of the switch unit 108 shown in FIG. 1A in accordance with another embodiment of the invention. The switch unit 108 (including the ports 110, 112, 114, 188, and 190, the receiver MEMS series switches 160 and 162, the transmitter MEMS series switch arrays 164 and 166, the transmitter MEMS shunt switches 168 and 170, interconnects 172, 174, 176, 178, 180, 182, 184, and 186, shown in FIG. 1L) shown in FIG. 1M is formed by connecting a receiver MEMS shunt switch 192 between the interconnect 180 and a port 194 and connecting a receiver MEMS shunt switch 196 between the interconnect 182 and a port 198.

In the transmit mode or if the receiver MEMS series switch 162 is closed, the receiver MEMS shunt switch 192 is closed and provides a conductive path from the port 114 to the port 194. Coupling the port 194 to a zero potential (not shown) protects the receiver 106 (shown in FIG. 1A) from electrostatic charge build-up at the port 114 by providing a discharge path from the port 114 to a zero potential at the port 194. Coupling the port 194 to a zero potential also increases the isolation between the receiver 106 (shown in FIG. 1A) and the transmitter 104 (shown in FIG. 1A) in the communication unit 100 (shown in FIG. 1A).

In the transmit mode or if the receiver MEMS series switch 160 is closed, the receiver MEMS shunt switch 196 is closed and provides a conductive path from the port 188 to the port 198. Coupling the port 198 to a zero potential (not shown) protects any receiver (not shown) from electrostatic charge build-up at the port 188 by providing a discharge path from the port 188 to a zero potential at the port 198. Coupling the port 198 to a zero potential also increases the isolation between a receiver coupled to the port 188 and any device coupled to the ports 112, 114, and 190.

To simplify the illustration of each of the embodiments of the switch unit 108 shown in FIGS. 1E, 1F, 1G, 1H, 1J, 1K, 1L, and 1M the drawings show only single switches (switches that provide only one conductive path) rather than an array of switches (switches that provide a plurality of parallel conductive paths) between the ports. However, the switch unit 108 is not limited to use in connection with single switches. An array of switches, such as the MEMS series switch array 148 (shown in FIG. 1H), can be substituted for any of the single switches shown in FIGS. 1E, 1F, 1G, 1H, 1J, 1K, 1L, and 1M. An array of switches provides redundancy. Redundancy improves reliability. Thus, the use of an array of switches in place of a single switch in the switch unit 108 enhances the reliability of the switch unit 108.

The micro-electrical-mechanical system (MEMS) switches shown in FIGS. 2A, 3A, 4A, and 5A and described below have electrical characteristics that make them suitable for use in connection with the switch unit shown in FIG. 1A. The MEMS switches exhibit low insertion loss (less than about 0.3 dB) and high isolation (greater than about 35 dB). Thus, these switches enable the design of the communication unit 100 (shown in FIG. 1A) which has lower power requirements, lower signal levels, and lower noise margins than existing systems.

FIG. 2A shows a top view of a (MEMS) series switch 200 suitable for use in connection with the communication unit 100 shown in FIG. 1A in accordance with another embodiment of the invention. The MEMS series switch 200 is formed on a substrate 206 and includes a cantilever 208 including a contact 210 and an actuation site 212. The cantilever 208 and the actuation site 212 are formed on the substrate 206. The contact 210 is formed on the cantilever 208. Interconnects 202 and 204 are formed on the substrate 206. The interconnect 202 is electrically coupled to the cantilever 208. The interconnect 204 is aligned with the contact 210.

FIG. 2B shows a side view of the MEMS series switch 200 shown in FIG. 2A in an open state. The actuation site 212 is not activated, the contact 210 is separated from the interconnect 204, and the interconnect 202 not electrically coupled to the interconnect 204.

FIG. 2C shows a side view of the MEMS series switch 200 shown in FIG. 2A in a closed state. The actuation site 212 is activated, the contact 210 touches the interconnect 204, and the interconnect 202 is electrically coupled to the interconnect 204.

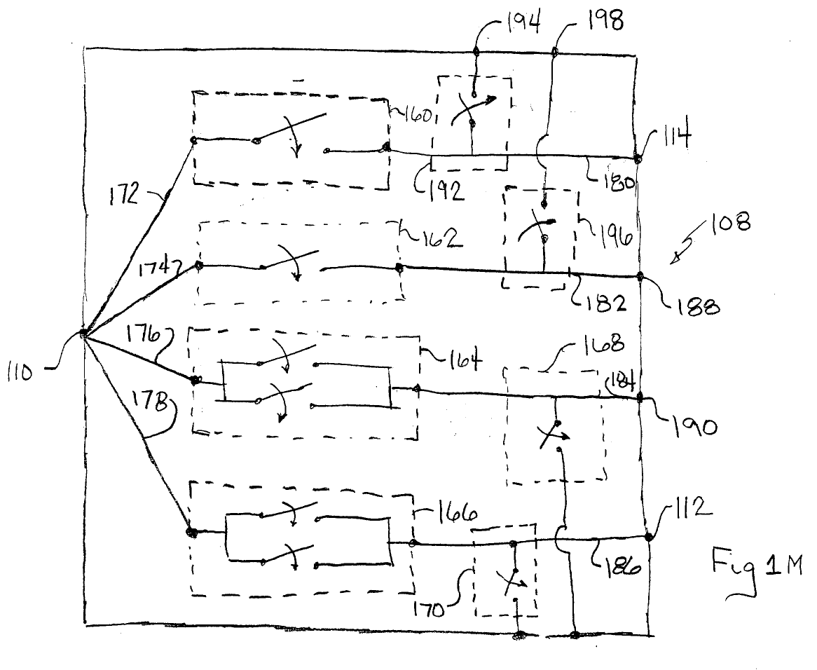

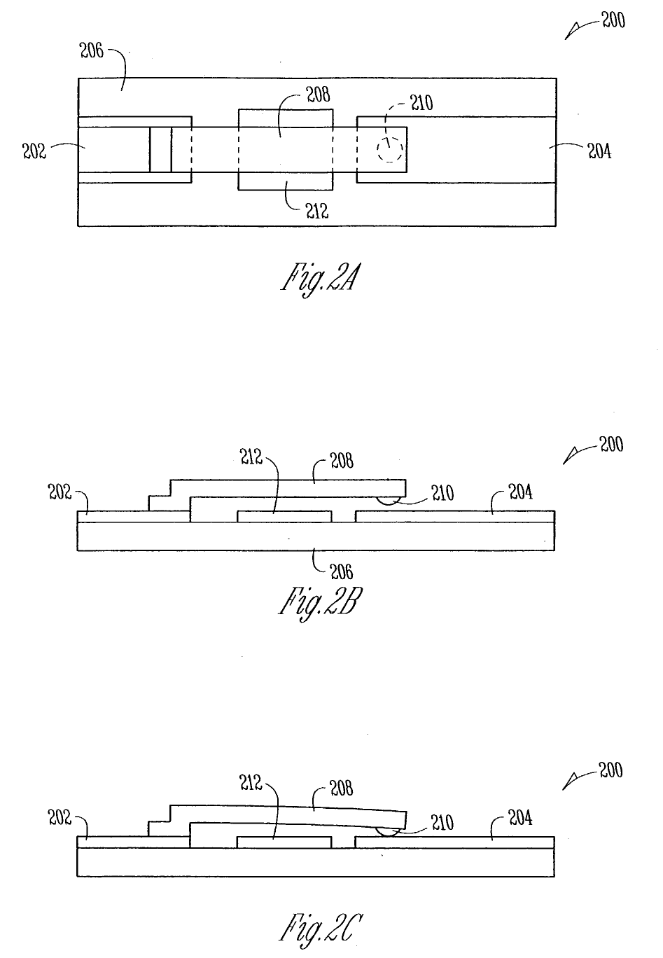

FIG. 3A shows a top view of a broad-side cantilever beam contact series switch 300 suitable for use in connection with the communication unit 100 shown in FIG. 1A in accordance with another embodiment of the invention. The broad-side cantilever beam contact series switch 300 is formed on a substrate 302 and includes a cantilever 304, contacts 306 and 308, and an actuation site 312. The contacts 306 and 308 are formed on a conductive segment 310 of the cantilever 304. The actuation site 312 is formed on the substrate 302. Interconnects 314 and 316 are formed on the substrate 302 and aligned with the contacts 306 and 308.

FIG. 3B shows a side view of the broad-side cantilever beam contact series switch 300 shown in FIG. 3A in an open state. The actuation site 312 is not activated, the contacts 306 and 308 are separated from the interconnects 314 and 316, and the interconnect 314 is not electrically coupled to the interconnect 316.

FIG. 3C shows a side view of the broad-side cantilever beam contact series switch 300 shown in FIG. 3A in a closed state. The actuation site 312 is activated, the contacts 306 and 308 touch the interconnects 314 and 316, and the interconnect 314 is electrically coupled to the interconnect 316.

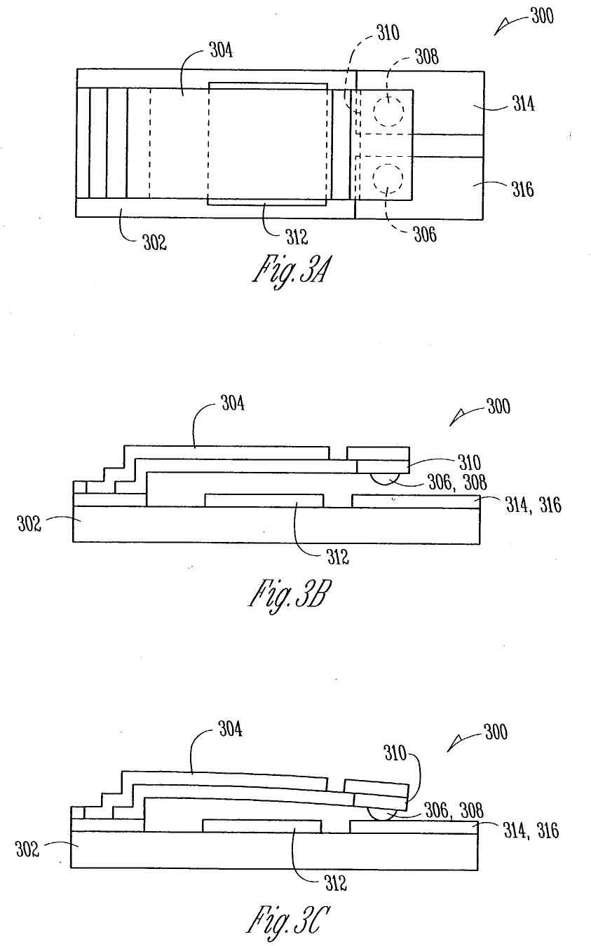

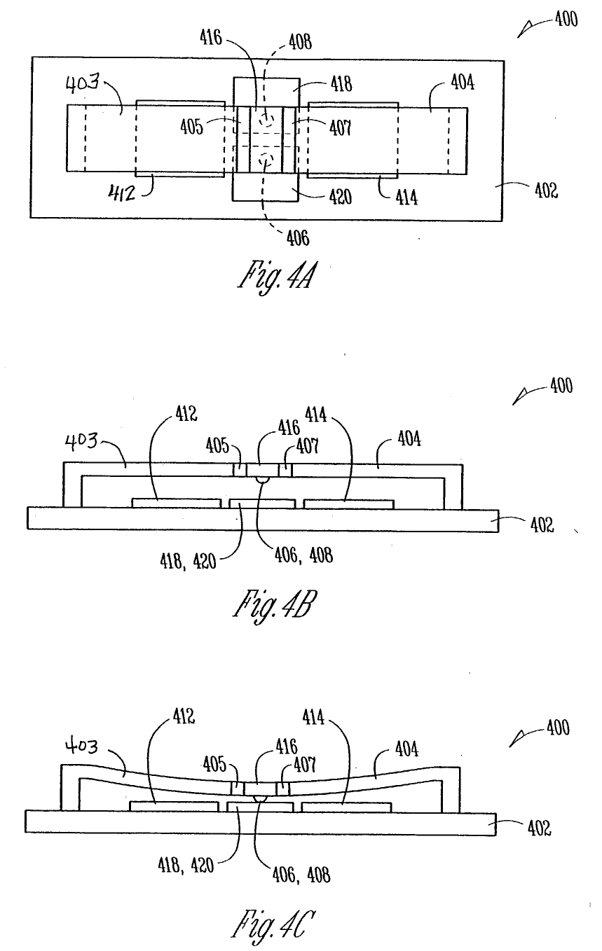

FIG. 4A shows a top view of a bridge-beam series switch 400 suitable for use in connection with the communication unit 100 shown in FIG. 1A in accordance with another embodiment of the invention. The bridge-beam series switch 400 is formed on a substrate 402 and includes bridge segments 403 and 404, non-conductive segments 405 and 407, contacts 406 and 408, actuation sites 412 and 414, and a conductive segment 416. The conductive segment 416 is formed from a conductive material. The contacts 406 and 408 are formed on the conductive segment 416. The conductive segment 416 is formed from a conductive material which electrically couples the contact 406 to the contact 408. The conductive segment 416 is electrically isolated from the bridge segment 403 by the non-conductive segment 405 and from the bridge segment 404 by the non-conductive segment 407. The non-conductive segments 405 and 407 are formed from a non-conductive material. The bridge segments 403 and 404 are not limited to being formed from a particular material. Conductive materials, non-conductive materials, and semiconductors are all suitable for use in forming the bridge segments 403 and 404.

FIG. 4B shows a side view of the bridge-beam series switch 400 shown in FIG. 4A in an open state. The actuation sites 412 and 414 are not activated, the contacts 406 and 408 are separated from the interconnects 418 and 420, and the interconnect 418 is not electrically coupled to the interconnect 420.

FIG. 4C shows a side view of the bridge-beam series switch 400 shown in FIG. 4A in a closed state. The actuation sites 412 and 414 are activated, the contacts 406 and 408 touch the interconnects 418 and 420, and the interconnect 418 is electrically coupled to the interconnect 420.

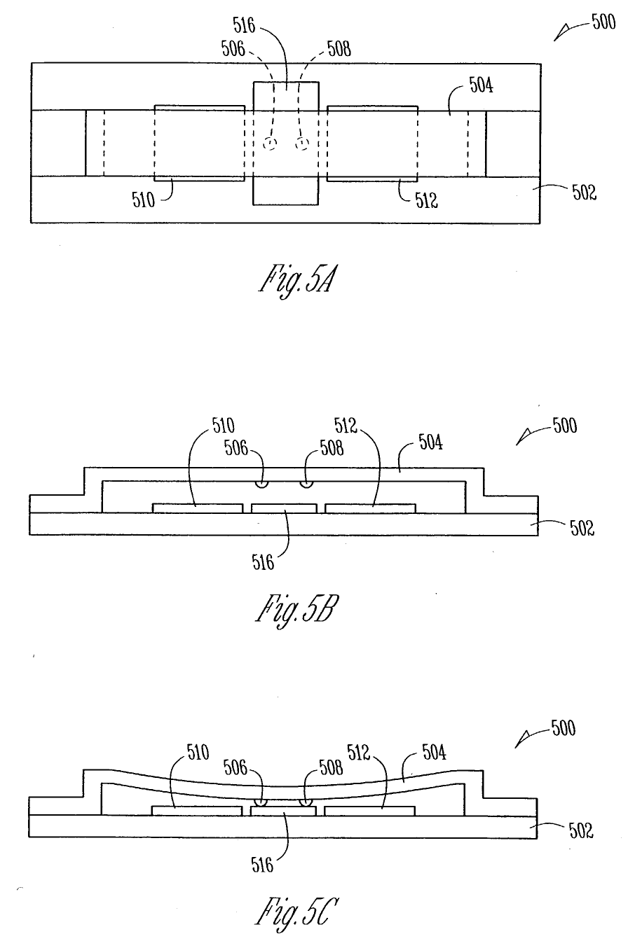

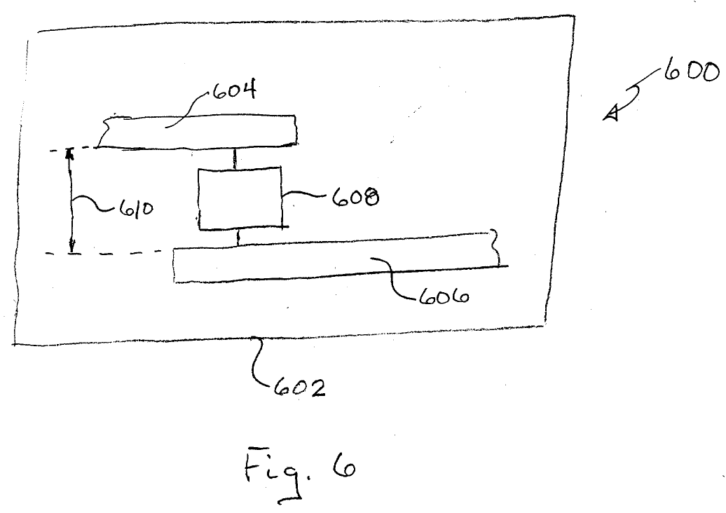

FIG. 5A shows a top view of a shunt switch 500 suitable for use in connection with the communication unit 100 shown in FIG. 1A in accordance with another embodiment of the invention. The shunt switch 500 is formed on a substrate 502, includes a bridge segment 504, contacts 506 and 508, and actuation sites 510 and 512. The bridge segment 504 is formed from a conductive material. The contacts 506 and 508 are formed on the bridge segment 504. An interconnect 516 is formed on the substrate 502 and aligned with the contacts 506 and 508.

FIG. 5B shows a side view of the shunt switch 500 shown in FIG. 5A in an open state. The actuation sites 510 and 512 are not activated, the contacts 506 and 508 are separated from the interconnect 516. Signals on the interconnect 516 are unaffected by any potential on the bridge segment 504.

FIG. 5C shows a side view of the shunt switch 500 shown in FIG. 5A in a closed state. The actuation sites 510 and 512 are activated, the contacts 506 and 508 touch the interconnect 516, and signals on the interconnect are influenced by any potential on the shunt switch 500.

The MEMS switches shown in FIGS. 2A, 3A, 4A, and 5A and described above include some common elements and methods. The switches include a substrate, one or more contacts, conductive structures, non-conductive structures, and an actuation method. The elements are formed from one or more types of materials.

Substrates are formed from semiconductors or ceramics. Exemplary semiconductors suitable for use in fabrication of substrates include silicon, germanium, gallium arsenide, indium phosphide, silicon-on-sapphire, and germanium-on-silicon. Exemplary ceramics suitable for use in the fabrication of the substrates include sintered alumina, silicon carbide, oxide glasses, and ceramic superconductors.

Contacts are formed from conductive materials. Exemplary conductive materials suitable for use in connection with the fabrication of contacts include metals, semiconductors, and polysilicon. Exemplary metals include gold, copper, and aluminum. Exemplary semiconductors include silicon, germanium, gallium arsenide, indium phosphide, silicon-on-sapphire, and germanium-on-silicon.

Conductive structures are formed from conductive materials and non-conductive structures are formed from dielectrics. Exemplary conductive materials suitable for use in connection with the fabrication of conductive structures include metals, semiconductors, and polysilicon. Non-conductive structures are formed from semiconductors or dielectrics. Exemplary dielectrics suitable for use in connection with the fabrication of non-conductive structures include semiconductors, oxides and nitrides.

Exemplary activation methods suitable for use in connection with the MEMS switches include electrostatic actuation, piezoelectric actuation, and electromagnetic actuation.

FIG. 6 shows a switch unit 600 suitable for use in connection with the communication unit 100 shown in FIG. 1A in accordance with another embodiment of the invention. The switch unit 600 includes a die 602, transmission lines 604 and 606, and a plurality of parallel MEMS switches 608. The die 602 is not limited to being fabricated from a particular material. Exemplary materials suitable for use in connection with the fabrication of the die 602 include semiconductors, such as silicon, gallium arsenide, germanium, and silicon-on-sapphire. The transmission lines 604 and 606 are formed from conductive materials on the die 602. The relative orientation of the transmission lines 604 and 606 is not limited to a particular orientation. In one embodiment, the transmission lines 604 and 606 run substantially parallel to one another. Exemplary conductive materials suitable for use in the fabrication of the transmission lines 604 and 606 include copper, alloys of copper, aluminum, alloys of aluminum, and polysilicon. The plurality of parallel MEMS switches 608 couple the transmission line 604 to the transmission line 606. The plurality of parallel MEMS switches 608 is not limited to a particular type of switch. Exemplary switch types suitable for use in connection with the MEMS coupled transmission line 600 include cantilever series switches and broad-side series switches. Each of the plurality of parallel MEMS switches 608 couples the transmission lines 604 to the transmission line 606. A switch length 610 substantially equal to the distance between the transmission lines being coupled together is suitable for use in connection with the communication unit 100 (shown in FIG. 1A). The switch unit 600 is suitable for use in a switchable connection between an antenna and a transceiver.

Although specific embodiments have been described and illustrated herein, it will be appreciated by those skilled in the art, having the benefit of the present disclosure, that any arrangement which is intended to achieve the same purpose may be substituted for a specific embodiment shown. This application is intended to cover any adaptations or variations of the present invention. Therefore, it is intended that this invention be limited only by the claims and the equivalents thereof.

What is claimed is:

1. A communication unit comprising a switch unit to couple an antenna to a transmitter and a receiver, the switch unit including a plurality of micro-electrical-mechanical-system (MEMS) switches.

2. The communication unit of claim 1, wherein the switch unit includes a receiver MEMS series switch to couple the antenna to the receiver and a transmitter MEMS shunt switch to couple the transmitter to a zero potential.

3. The communication unit of claim 2, further comprising a phase-shifter to couple the antenna to the transmitter MEMS shunt switch.

4. The communication unit of claim 3, further comprising a receiver MEMS shunt switch to couple the receiver to a zero potential.

5. The communication unit of claim 4, wherein the switch unit is formed on a silicon substrate.

6. The communication unit of claim 1, wherein the switch unit includes a receiver MEMS series switch to couple the antenna to the receiver and a transmitter MEMS series switch array to couple the antenna to the transmitter.

7. The communication unit of claim 6, further comprising a phase-shifter to couple the antenna to the transmitter MEMS series switch array.

8. The communication unit of claim 7, further comprising a transmitter MEMS shunt switch to couple the transmitter to a zero potential.

9. The communication unit of claim 8, further comprising a receiver MEMS shunt switch to couple the receiver to a zero potential.

10. The communication unit of claim 9, wherein the switch unit is formed on a gallium arsenide substrate.

11. A communication unit comprising:
a plurality of antennae;
a plurality of transmitters and receivers; and
a switch unit to couple the plurality of antennae to the plurality of transmitters and receivers, the switch unit including a plurality of MEMS switches.

12. The communication unit of claim 11, wherein at least one of the plurality of transmitters and receivers comprises a Global System for Mobile Communication (GSM) transmitter and at least one of the plurality of transmitters and receivers comprises a GSM receiver.

13. The communication unit of claim 11, wherein at least one of the plurality of transmitters and receivers comprises a combination Global System for Mobile Communication (GSM)/Code Division Multiple Access (CDMA) transmitter and at least one of the plurality of transmitters and receivers comprises a GSM/CDMA receiver.

14. The communication unit of claim 13, wherein the switch unit is formed on a silicon substrate.

15. A switch unit comprising:
a die;
a first transmission line formed on the die;
a second transmission line formed on the die; and
a plurality of parallel MEMS switches to couple the first transmission line to the second transmission line.

16. The switch unit of claim 15, wherein the die comprises silicon.

17. The switch unit of claim 16, wherein at least one of the parallel MEMS switches has an insertion loss of less than about 0.3 dB.

18. The switch unit of claim 15, wherein the die comprises germanium.

19. The switch unit of claim 18, wherein each of the plurality of MEMS switches comprises a MEMS cantilever series switch.

20. The switch unit of claim 19, wherein at least one of the plurality of parallel MEMS switches exhibits isolation of greater than about 35 dB.

21. The switch unit of claim 15, wherein the die comprises gallium arsenide.

22. The switch unit of claim 21, further comprising a MEMS cantilever switch connected between the first transmission line and a zero potential.

23. The switch unit of claim 15, wherein the die comprises gallium arsenide.

24. The switch unit of claim 23, wherein each of the plurality of MEMS switches comprises a MEMS broad-side series switch.

25. The switch unit of claim 15, further comprising a MEMS broad-side switch to couple the first transmission line to a zero potential.
